(19) United States
(12) Patent Application Publication
(10) Pub. No.: US 2023/0083058 A1
(43) Pub. Date: Mar. 16, 2023

(54) WHEELED ASSEMBLY

(71) Applicant: HITCH HOTEL, INC., Valencia, CA (US)

(72) Inventors: Geoff Patterson, Valencia, CA (US); Geremy Patterson, Valencia, CA (US); Grant Nelson, Valencia, CA (US)

(21) Appl. No.: 17/801,720

(22) PCT Filed: Feb. 24, 2021
(86) PCT No.: PCT/US2021/019451

§ 371 Date: Aug. 23, 2022

Related U.S. Application Data
(60) Provisional application No. 62/980,828, filed on Feb. 24, 2020.

(51) Int. Cl. B62D 63/06; B60D 1/06; B60D 1/167; B60D 1/66

(52) U.S. Cl. CPC B62D 63/062; B60D 1/06; B60D 1/1675; B60D 1/665

(57) ABSTRACT

A wheeled assembly configured to support a trailer. The wheeled assembly includes a frame, a pair of wheels coupled to the frame, a tongue hingedly coupled to a front end portion of the frame that is configured to rotate between a deployed configuration and a stowed configuration, a hitch coupler coupled to the tongue that is configured to connect to a tow vehicle, and a pair of stabilizing jacks coupled to opposite sides of the frame.

### CROSS-REFERENCE TO RELATED APPLICATION

The present application claims priority to and the benefit of U.S. Provisional Application No. 62/980,828, filed Feb. 24, 2020 in the U.S. Patent and Trademark Office, the entire content of which is incorporated herein by reference.

### BACKGROUND

### 1. Field

Embodiments of the present disclosure relate to a wheeled assembly, an assembly including a wheelless trailer and a wheeled assembly, a method of retrofitting a wheelless trailer with a wheeled assembly.

### 2. Description of the Related Art

Automobile trailers are typically hitched to an automobile for transport to a remote location. After hitching the trailer to the automobile, the driver may drive the trailer to the remote location. Many storage trailers and camping trailers are typically large enough to fit one or more adult people, equipment, or other large objects, and may have a length from between 6 to 12 feet behind the automobile. Such trailers commonly require large road-capable wheels for transport. Furthermore, when transporting large trailers, the operator is typically subjected to additional speed and lane restrictions that are not required for vehicles without a trailer. Much smaller storage compartments that may be mounted to a vehicle such as on top or on the rear do not require wheels and do not require speed and lane restrictions. However, such storage compartments do not have enough storage capacity for larger objects such as one or more adult people.

### BRIEF DESCRIPTION OF THE DRAWINGS

Features and advantages of embodiments of the present disclosure will become apparent by reference to the following detailed description when considered in conjunction with the following drawings. In the drawings, like reference numerals are used throughout the figures to reference like features and components. The figures are not necessarily drawn to scale.

FIG. 1 is a front perspective view of a wheeled assembly according to one embodiment of the present disclosure in a deployed position;

FIG. 2 is a side perspective view of the embodiment of the wheeled assembly illustrated in FIG. 1 in a stowed position; and

FIG. 3 is a side perspective view of the embodiment of the wheeled assembly illustrated in FIG. 1 in a stowed position and attached to a trailer according to one embodiment of the present disclosure.

### SUMMARY

The present disclosure relates to various embodiments of a wheeled assembly. In one embodiment, the wheeled assembly includes a frame, a pair of wheels coupled to the frame, a tongue hingedly coupled to a front end portion of the frame that is configured to rotate between a deployed configuration and a stowed configuration, a hitch coupler coupled to the tongue that is configured to connect to a tow vehicle, and a pair of stabilizing jacks coupled to opposite sides of the frame.

The wheeled assembly may also include a hitch receiver coupled to a rear end portion of the frame.

The frame may include a pair of side rails extending longitudinally and substantially parallel to each other, a front cross member extending transversely between the pair of side rails proximate to the front end portion of the frame, and a rear cross member extending transversely between the pair of side rails proximate to a rear end portion of the frame.

The frame may also include a pair of flanges coupled to the pair of side rails.

The wheeled assembly may also include a series of openings in the pair of flanges configured to receive fasteners securing the wheeled assembly to the trailer.

The tongue may include a cross member, and a pair of angled members extending away from the frame and inward toward each other from opposite sides of the cross member.

Each stabilizing jack of the pair of stabilizing jacks may be configured to rotate relative to the frame between a deployed configuration and a stowed configuration.

The wheeled assembly may include a pair of clevises hingedly coupling the tongue to the frame.

Each stabilizing jack of the pair of stabilizing jacks may be a wheeled stabilizing jack.

The wheeled assembly may also include a storage container coupled to the frame.

The present disclosure also relates to various embodiments of a trailer assembly. In one embodiment, the trailer assembly includes a wheelless trailer, and a wheeled assembly configured to be detachably coupled to the wheelless trailer. In one embodiment, the wheeled assembly includes a frame configured to support the wheelless trailer, a pair of wheels coupled to the frame, a tongue hingedly coupled to a front end portion of the frame that is configured to rotate between a deployed configuration and a stowed configuration, a hitch coupler coupled to the tongue that is configured to connect to a tow vehicle, and a pair of stabilizing jacks coupled to opposite sides of the frame.

A configuration of the frame may match a configuration of a base portion of the wheelless trailer.

When the wheeled assembly is coupled to the wheelless trailer and the tongue is in the stowed configuration, the tongue may extend upward along a front wall of the wheelless trailer.

Each stabilizing jack of the pair of stabilizing jacks may be configured to rotate relative to the frame between a deployed configuration and a stowed configuration.

When the wheeled assembly is coupled to the wheelless trailer and the pair of stabilizing jacks are in the stowed configuration, the pair of stabilizing jacks may be at least partially stowed underneath the wheelless trailer.

When the wheeled assembly is coupled to the wheelless trailer and the pair of stabilizing jacks are in the deployed configuration, the pair of stabilizing jacks may be configured to raise and lower the trailer assembly to detach and attach the trailer assembly to a tow vehicle.

The trailer assembly may also include a hitch receiver coupled to a rear end portion of the frame.

The frame may include a pair of side rails extending longitudinally and substantially parallel to each other, a front cross member extending transversely between the pair of side rails proximate to the front end portion of the frame, a rear cross member extending transversely between the pair of side rails proximate to a rear end portion of the frame, and a pair of flanges coupled to the pair of side rails.

The trailer assembly may include a series of openings in the pair of flanges configured to receive fasteners securing the wheeled assembly to the wheelless trailer.

The tongue may include a cross member, and a pair of angled members extending away from the frame and inward toward each other from opposite sides of the cross member.

The trailer assembly may include a pair of clevises hingedly coupling the tongue to the frame.

This summary is provided to introduce a selection of concepts that are further described below in the detailed description. This summary is not intended to identify key or essential features of the claimed subject matter, nor is it intended to be used in limiting the scope of the claimed subject matter. One or more of the described features and/or tasks may be combined with one or more other described features and/or tasks to provide a workable device and/or a workable method.

### DETAILED DESCRIPTION

The present disclosure relates to various embodiments of a wheeled assembly configured to enable wheeled transportation (e.g., by towing) of a trailer. In one or more embodiments, the wheeled assembly of the present disclosure is configured to convert or retrofit a wheelless trailer into a wheeled trailer.

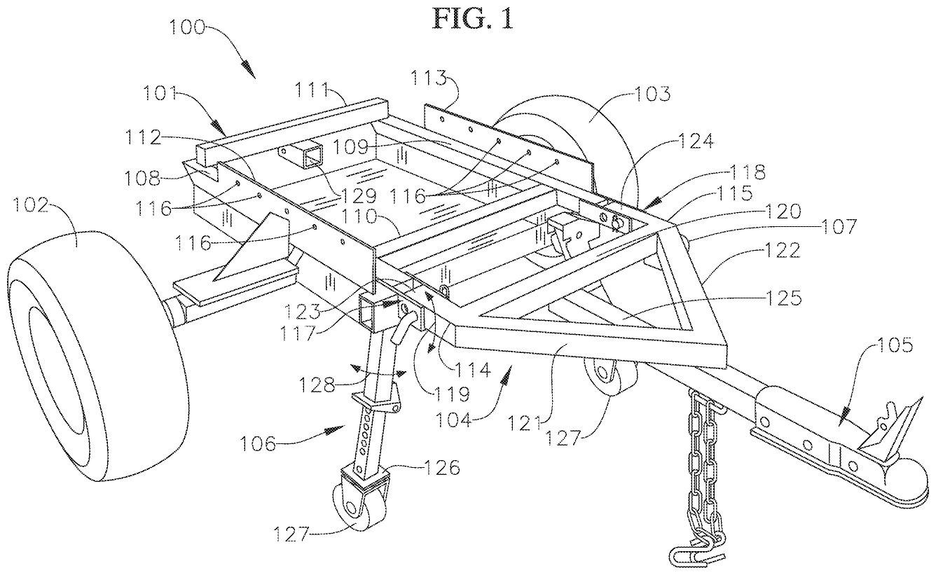

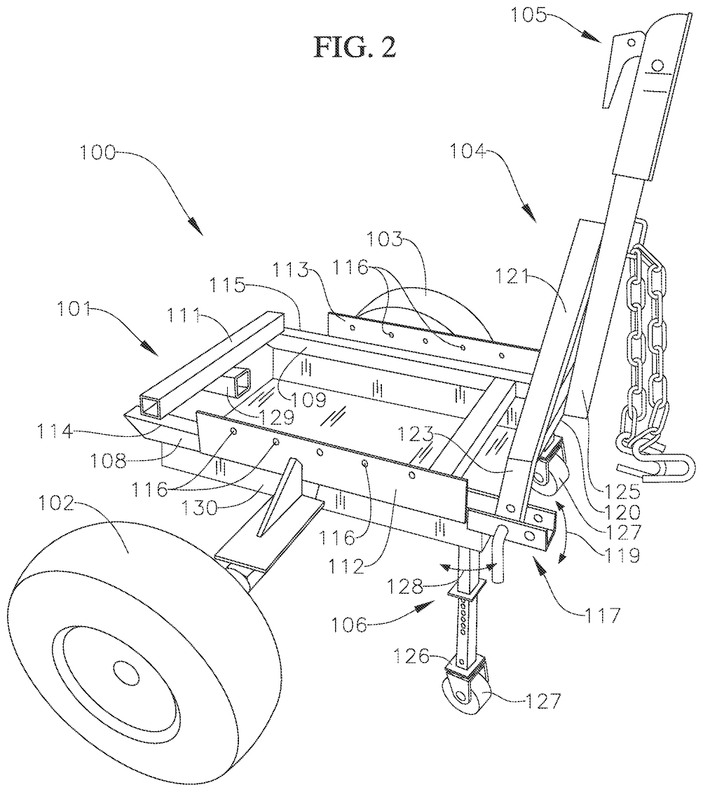

With reference now to the embodiment illustrated in FIGS. 1 and 2, a wheeled assembly 100 according to one embodiment of the present disclosure includes a frame 101, a pair of wheels 102, 103 coupled to the frame 101, a tongue 104 hingedly coupled to a front end portion of the frame 101, a hitch coupler 105 coupled to the tongue 104, and a pair of stabilizing jacks 106, 107 coupled to opposite sides of the frame 101.

In the illustrated embodiment, the frame 101 includes a pair of side rails 108, 109 extending longitudinally and parallel or substantially parallel to each other, a front cross member 110 extending transversely between the side rails 108, 109 proximate to the front end of the frame 101, and a rear cross member 111 extending transversely between the side rails 108, 109 proximate to a rear end of the frame 101. Additionally, in one or more embodiments, the configuration (e.g., the shape and size) of the frame 101 is configured to match or substantially match the configuration (e.g., the shape and size) of the trailer that it is designed to support. That is, in one or more embodiments, the “footprint” of the frame 101 is configured to match or substantially match the “footprint” of the trailer that it is designed to support. For instance, in one or more embodiments, the configuration (e.g., the shape and size) of the frame 101 is configured to match or substantially match the configuration (e.g., the shape and size) of structural framework along a base or floor of the trailer that it is designed to support. In one or more embodiments, the trailer may be the extendable compartment trailer disclosed in U.S. application Ser. No. 14/708,137, filed on May 8, 2015 (which issued as U.S. Pat. No. 9,636,958), the entire contents of which are incorporated herein by reference. Accordingly, although in the illustrated embodiment the frame 101 is rectangular, in one or more embodiments, the frame 101 may have any other suitable shape depending, for instance, on the shape of the trailer that it is designed to support. Providing the frame 101 in the same configuration (e.g., size and shape) as the trailer that it is designed to support is configured to minimize or at least reduce the overall storage size of the trailer and the wheeled assembly 100.

In the illustrated embodiment, the frame 101 also includes a pair of flanges 112, 113 extending upwards from the side rails 108, 109, respectively, and longitudinally along at least a portion of outer edges 114, 115 of the side rails 108, 109, respectively. Additionally, in the illustrated embodiment, each of the flanges 112, 113 includes a series of openings 116 (e.g., holes) configured to receive fasteners for securing a trailer to the frame 101 of the wheeled assembly 100. The configuration (e.g., shape, size, arrangement, and number) of the openings 116 is configured to match the configuration (e.g., shape, size, arrangement, and number) of the openings in the trailer that the wheeled assembly 100 is designed to support. However, in one or more embodiments, the configuration of the openings 116 in the flanges 112, 113 may not match the configuration of the openings in the trailer. For instance, in one or more embodiments, the openings 116 in the flanges 112, 113 may elongated openings (e.g., slots) at least a portion of which is configured to overlap with the openings in the trailer, or the openings 116 in the flanges 112, 113 may include two or more different patterns of openings, so that the openings 116 in the flanges 112, 113 may be aligned with a variety of different hole patterns in the trailer (i.e., the openings 116 in the flanges 112, 113 may be “universal” such that the flanges 112, 113 of the frame 101 may be coupled to two or more different types of trailers having different arrangements of openings).

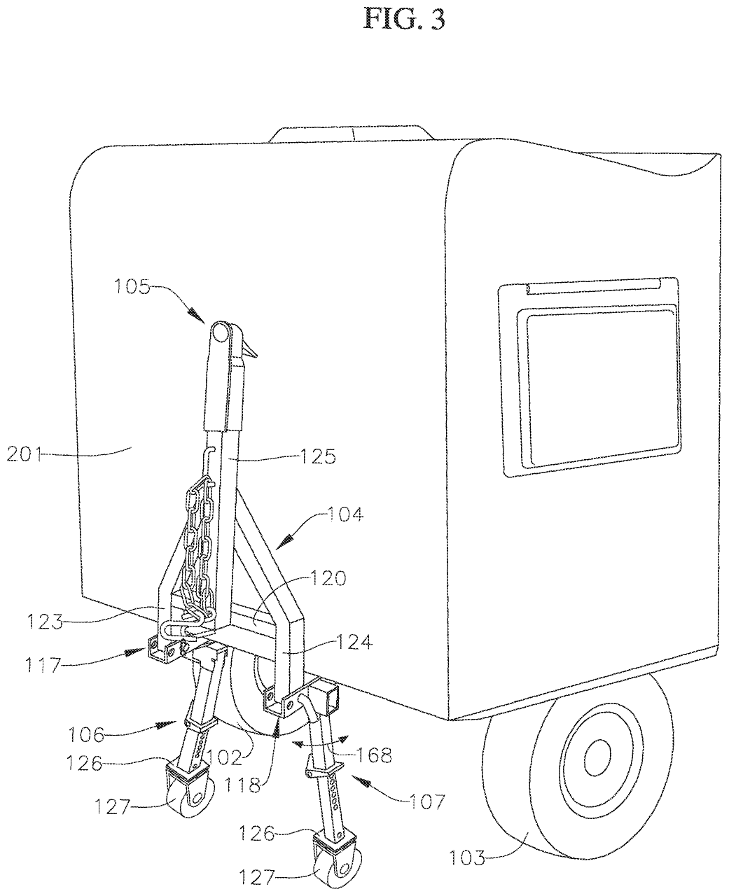

In the illustrated embodiment, a front end of each of the side rails 108, 109 includes a clevis 117, 118, respectively (e.g., a pair of prongs spaced apart by an opening each having an opening). As described in more detail below, the clevises 117, 118 are configured to enable the tongue 104 to rotate (arrow 119) relative to the frame 101 between a deployed position (shown in FIG. 1) and a stowed position (shown in FIGS. 2 and 3).

In the illustrated embodiment, the tongue 104 includes a cross member 120 and a pair of angled members 121, 122 extending forward and inward from opposite sides of the cross member 120. Forward ends of the angled members 121, 122 are joined together at an apex or a tip. Together, the cross member 120 and the pair of angled members 121, 122 are arranged in a triangular configuration. Additionally, in the illustrated embodiment, the tongue 104 includes a pair of tangs 123, 124 extending rearward from the opposite ends of the cross member 120. The tangs 123, 124 of the tongue 104 are configured to extend into the openings in the clevises 117, 118 of the frame 101. Additionally, the tangs 123, 124 of the tongue 104 each include an opening configured to accommodate a fastener (e.g., a clevis pin). In the illustrated embodiment, the tongue 104 is hingedly (arrow 119) coupled to the frame 101 by inserting the tangs 123, 124 into the openings of the clevises 117, 118 and, for each tang 123, 124 and its corresponding clevis 117, 118, inserting a fastener (e.g., a clevis pin) through the openings in the clevis 117, 118 and the corresponding openings in the tang 123, 124.

The tongue 104 also includes a longitudinal member 125 coupled to the cross member 120 and the angled members 121, 122. In the illustrated embodiment, the longitudinal member 125 is laterally centered on the tongue 104 such that the longitudinal member 125 is coupled to a central portion of the cross member 120 and the apex of the angled members 121, 122. Additionally, in the illustrated embodiment, the longitudinal member 125 is coupled to the underside of the cross member 120 and the angled members 121, 122. Accordingly, when the trailer 200 is coupled to the frame 101 and the tongue 104 is in the stowed position, as illustrated in FIG. 3, the longitudinal member 125 does not contact the trailer 200. In the illustrated embodiment, when the trailer 200 is coupled to the frame 101 and the tongue 104 is in the stowed position, as illustrated in FIG. 3, the tongue 104 extends upward along a portion of a front wall 201 of the trailer 200.

Additionally, in the illustrated embodiment, the longitudinal member 125 extends forward beyond the apex of the angled members 121, 122. The hitch coupler 105 is coupled to a forward portion of the longitudinal member 125 that extends beyond the apex of the angled members 121, 122. In one or more embodiments, the hitch coupler 105 may be detachable from the longitudinal member 125 such that the appropriate type of hinge coupler may be coupled to the tongue 104 depending on the configuration of the hitch of the tow vehicle.

In the illustrated embodiment, the pair of stabilizing jacks 106, 107 are coupled to outer sides of the side rails of the frame 101. The stabilizing jacks 106, 107 are configured to stabilize the wheeled assembly 100 and the trailer when they are detached from the tow vehicle. In one or more embodiments, a lower end of each of the stabilizing jacks 106, 107 that is configured to engage the ground may include a flat plate 126 and/or one or more wheels 127. Additionally, in the illustrated embodiment, the stabilizing jacks 106, 107 are rotatable (arrow 128) relative to the frame 101. The stabilizing jacks 106, 107 are configured to rotate (arrow 128) between a deployed position (shown in FIGS. 1 and 2) for use when the trailer and the wheeled assembly 100 are immobile (e.g., not being towed by the tow vehicle) and a stowed position underneath the frame 101 and the trailer when the wheeled assembly 100 and the trailer are in motion (e.g., during transport by the tow vehicle). Moreover, although in the illustrated embodiment the stabilizing jacks 106, 107 are manual stabilizing jacks (e.g., hand-crank jacks), in one or more embodiments, the stabilizing jacks 106, 107 may be any other suitable kind of stabilizing jacks, such as, for instance, pneumatic, electro-mechanical, or hydraulic stabilizing jacks.

In the illustrated embodiment, the wheeled assembly 100 also includes a hitch receiver 129 coupled to the rear cross member 111 of the frame 101. The hitch receiver 129 is configured to enable attachment of another device besides the trailer to the wheeled assembly 100, such as, for example, a bike rack or a storage rack.

Additionally, in the illustrated embodiment, the wheeled assembly 100 also includes a storage compartment or container 130 coupled to the underside of the frame 101. In one or more embodiments, the storage compartment 130 is accessible from the floor inside of the trailer that is supported by the wheeled assembly 100.

While this invention has been described in detail with particular references to exemplary embodiments thereof, the exemplary embodiments described herein are not intended to be exhaustive or to limit the scope of the invention to the exact forms disclosed. Persons skilled in the art and technology to which this invention pertains will appreciate that alterations and changes in the described structures and methods of assembly and operation can be practiced without meaningfully departing from the principles, spirit, and scope of this invention.

1. A wheeled assembly configured to support a trailer, the wheeled assembly comprising:
a frame;
a pair of wheels coupled to the frame;
a tongue hingedly coupled to a front end portion of the frame, wherein the tongue is configured to rotate between a deployed configuration and a stowed configuration;
a hitch coupler coupled to the tongue, the hitch coupler being configured to connect to a tow vehicle;
a pair of stabilizing jacks coupled to opposite sides of the frame; and
a pair of clevises hingedly coupling the tongue to the frame.

2. The wheeled assembly of claim 1, further comprising a hitch receiver coupled to a rear end portion of the frame.

3. The wheeled assembly of claim 1, wherein the frame comprises:
a pair of side rails extending longitudinally and substantially parallel to each other;
a front cross member extending transversely between the pair of side rails and proximate to the front end portion of the frame; and
a rear cross member extending transversely between the pair of side rails proximate to a rear end portion of the frame.

4. The wheeled assembly of claim 3, wherein the frame further comprises a pair of flanges coupled to the pair of side rails.

5. A wheeled assembly configured to support a trailer, the wheeled assembly comprising:
a frame;
a pair of wheels coupled to the frame;
a tongue hingedly coupled to a front end portion of the frame, wherein the tongue is configured to rotate between a deployed configuration and a stowed configuration;
a hitch coupler coupled to the tongue, the hitch coupler being configured to connect to a tow vehicle; and
a pair of stabilizing jacks coupled to opposite sides of the frame,
wherein the frame comprises:
a pair of side rails extending longitudinally and substantially parallel to each other;
a front cross member extending transversely between the pair of side rails and proximate to the front end portion of the frame;
a rear cross member extending transversely between the pair of side rails proximate to a rear end portion of the frame;
a pair of flanges coupled to the pair of side rails; and
a plurality of openings in the pair of flanges configured to receive fasteners securing the wheeled assembly to the trailer.

6. The wheeled assembly of claim 1, wherein the tongue comprises:
a cross member; and
a pair of angled members extending away from the frame and inward toward each other from opposite sides of the cross member.

7. The wheeled assembly of claim 1, wherein each stabilizing jack of the pair of stabilizing jacks is configured to rotate relative to the frame between a deployed configuration and a stowed configuration.

8. (canceled)

9. The wheeled assembly of claim 1, wherein each stabilizing jack of the pair of stabilizing jacks is a wheeled stabilizing jack.

10. The wheeled assembly of claim 1, further comprising a storage container coupled to the frame.

11. A trailer assembly, comprising:
a wheelless trailer; and
a wheeled assembly configured to be detachably coupled to the wheelless trailer, the wheeled assembly comprising:
a frame configured to support the wheelless trailer;
a pair of wheels coupled to the frame;
a tongue hingedly coupled to a front end portion of the frame, wherein the tongue is configured to rotate between a deployed configuration and a stowed configuration;
a hitch coupler coupled to the tongue, the hitch coupler being configured to connect to a tow vehicle; and
a pair of stabilizing jacks coupled to opposite sides of the frame.

12. The trailer assembly of claim 11, wherein a configuration of the frame matches a configuration of a base portion of the wheelless trailer.

13. The trailer assembly of claim 11, wherein, when the wheeled assembly is coupled to the wheelless trailer and the tongue is in the stowed configuration, the tongue extends upward along a front wall of the wheelless trailer.

14. The trailer assembly of claim 11, wherein each stabilizing jack of the pair of stabilizing jacks is configured to rotate relative to the frame between a deployed configuration and a stowed configuration, and wherein, when the wheeled assembly is coupled to the wheelless trailer and the pair of stabilizing jacks are in the stowed configuration, the pair of stabilizing jacks are at least partially stowed underneath the wheelless trailer.

15. The trailer assembly of claim 14, wherein, when the wheeled assembly is coupled to the wheelless trailer and the pair of stabilizing jacks are in the deployed configuration, the pair of stabilizing jacks are configured to raise and lower the trailer assembly to detach and attach the trailer assembly to a tow vehicle.

16. The trailer assembly of claim 11, further comprising a hitch receiver coupled to a rear end portion of the frame.

17. The trailer assembly of claim 11, wherein the frame comprises:
a pair of side rails extending longitudinally and substantially parallel to each other;
a front cross member extending transversely between the pair of side rails proximate to the front end portion of the frame;
a rear cross member extending transversely between the pair of side rails proximate to a rear end portion of the frame; and
a pair of flanges coupled to the pair of side rails.

18. The trailer assembly of claim 17, further comprising a plurality of openings in the pair of flanges configured to receive fasteners securing the wheeled assembly to the wheelless trailer.

19. The trailer assembly of claim 11, wherein the tongue comprises:
a cross member; and
a pair of angled members extending away from the frame and inward toward each other from opposite sides of the cross member.

20. The trailer assembly of claim 11, further comprising a pair of clevises hingedly coupling the tongue to the frame.
